(19) United States
(12) Patent Application Publication
(10) Pub. No.: US 2009/0263597 A1
(43) Pub. Date: Oct. 22, 2009

(54) METHOD FOR MANUFACTURING A HOUSING

(75) Inventors: Kun-Tsan Wu, Shindian (TW); Li-Wen Tien, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (Hong Kong) Limited, Kowloon (HK)

(21) Appl. No.: 12/399,227

(22) Filed: Mar. 6, 2009

(30) Foreign Application Priority Data
Apr. 22, 2008 (CN) 200810301237.8

(51) Int. Cl. B32B 1/06; B29C 45/14

(52) U.S. Cl. 428/34.1; 264/271.1; 264/101; 428/36.1

(57) ABSTRACT

A method for manufacturing a housing, comprising providing a buffer cushion, fixing the buffer cushion in an injection mold, and injecting molten material into the injection mold to form a housing, with the housing being attached to the buffer cushion.

### BACKGROUND OF THE INVENTION

1. Technical field

The present disclosure generally relates to housing manufacture, particularly to a method for manufacturing a housing with a buffer cushion utilizing injection molding.

2. Description of Related Art

Currently, portable electronic devices such as mobile phones, laptops and personal digital assistants (PDAs) in widespread use incorporate housings of plastic. Upon impact, however, electronic elements of the portable electronic devices received therein may easily be damaged.

A typical housing of a portable electronic devices usually includes a buffer cushion to reduce such damage. As an example, a housing may include a display window and an LCD (liquid crystal display) vertically aligned with the display window. A buffer cushion may be positioned around the display window to protect the LCD. Upon impact, the buffer cushion absorbs shock received between the LCD and the housing to protect the LCD.

The buffer cushion is often manually positioned on the housing during manufacture, via application of viscose glue to the cushion followed by direct attachment thereof to the housing. Such process can reduce processing efficiency and increase production times.

Therefore, there is room for improvement within the art.

### BRIEF DESCRIPTION OF THE DRAWINGS

Many aspects of method for manufacturing a housing can be better understood with reference to the following drawing. The components in the drawing are not necessarily drawn to scale, the emphasis instead being placed upon clearly illustrating the principles of the method for manufacturing a housing. Moreover, in the drawing like reference numerals designate corresponding parts throughout the several views, in which

FIG. 1 is a schematic, exploded view of an exemplary embodiment of a housing;

FIG. 2 is a cross-section of an injection mold for manufacture of the housing;

FIG. 3 is a cross-section of the injection mold shown in FIG. 2, closed to form the housing; and

FIG. 4 is a cross-section of another structure of the injection mold shown in FIG. 2.

### DETAILED DESCRIPTION OF THE PREFERRED EMBODIMENTS

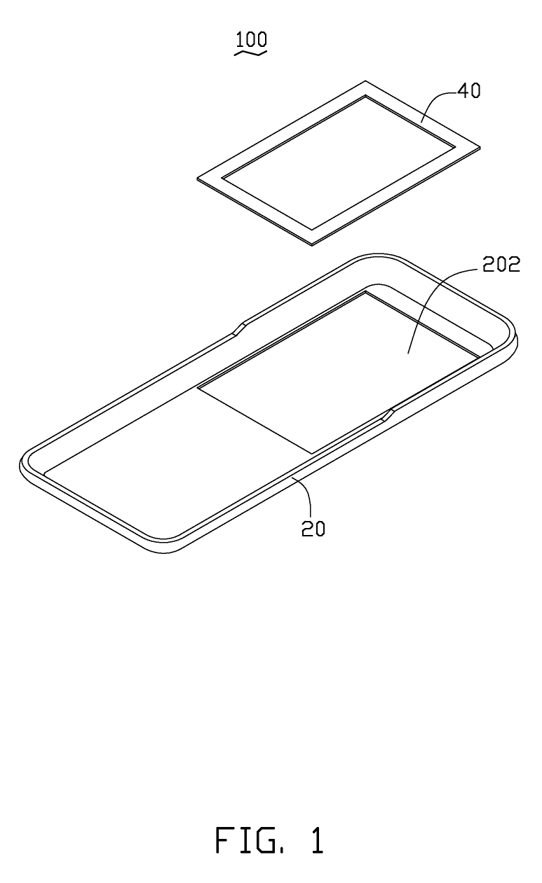

Referring to FIG. 1, in an exemplary embodiment, a housing 100 includes a main body 20 and a buffer cushion 40 positioned thereon.

The main body 20 includes a display window 202 disposed therein. The buffer cushion 40 is substantially a frame positioned around the display window 202. The buffer cushion 40 can be fabric, rubber, or other resilient material.

A method for manufacturing the housing 100 with the buffer cushion 40 follows.

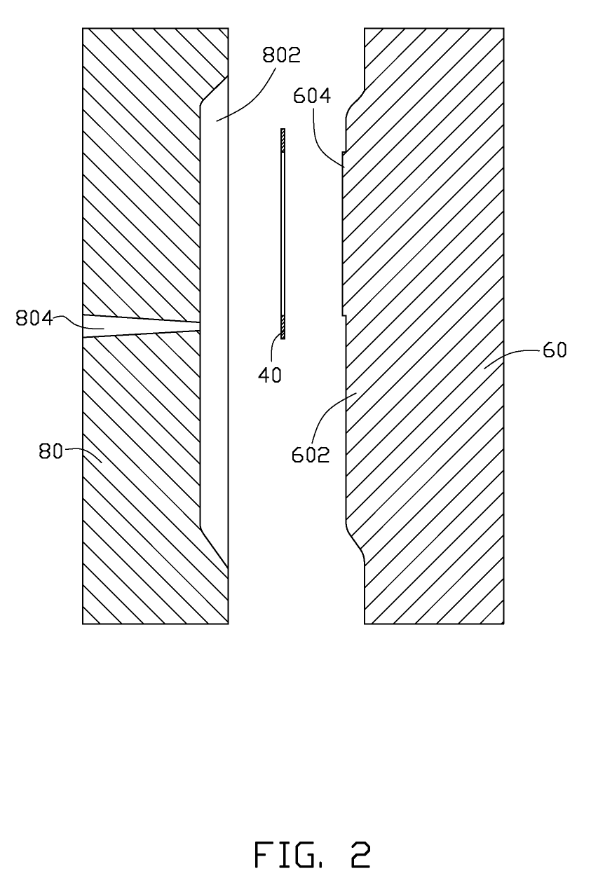

Referring to FIG. 2, an injection mold is provided. The injection mold includes a male mold 60 facing a female mold 80. The male mold 60 includes a protruding portion 602 formed thereon. The protruding portion 602 has a positioning portion 604 extending therefrom. The positioning portion 604 is the same height as the thickness of the buffer cushion 40. The female mold 80 defines a cavity 802 therein. A runner 804 penetrates the female mold 80 and communicates with the cavity 802.

The buffer cushion 40 is positioned around the positioning portion 604 when the injection mold is opened.

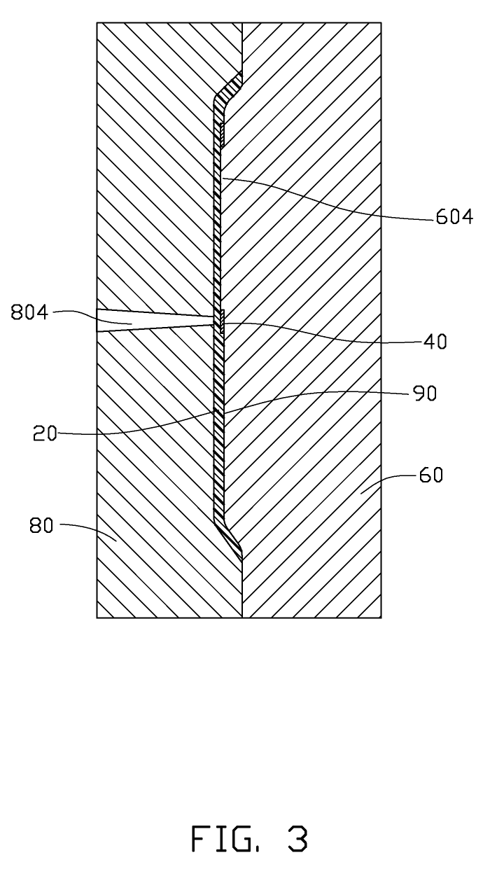

Referring to FIG. 3, the male mold 60 and the female mold 80 are closed, cooperatively defining a die chamber 90 therewithin, in which buffer cushion 40 is received.

Molten material is injected into the die chamber 90 through the runner 804 when a temperature of the injection mold reaches about 255 degrees C. (° C.). The melted material can be polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. When the die chamber 90 is completely filled with the melted material, the buffer cushion 40 is embedded into the melted material.

Finally, the melted material is cooled to form the main body 20. The buffer cushion 40 is attached to the main body 20 to form the housing 100. The method for manufacturing the housing 100 with the buffer cushion 40 by the injection mold increases processing efficiency and reduces production timeframe.

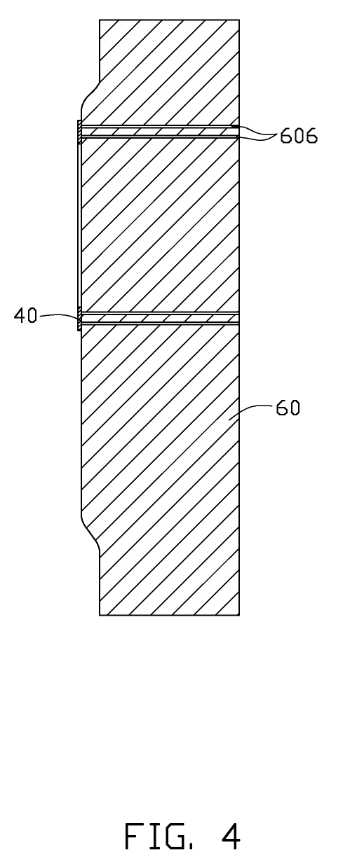

Referring to FIG. 4, it is to be understood that the male mold 60 defines a plurality of air suction holes 606. During injection molding of main body 20, the buffer cushion 40 is drawn against the male mold 60 by vacuum pressure through the air suction holes 606.

It is to be understood that the positioning portion 604 can also include at least three positioning posts, by which the buffer cushion 40 is positioned on the male mold 60.

It is to be understood that the height of the protruding portion 602 may also exceed the thickness of the buffer cushion 40. When the injection mold is closed, the protruding portion 602 resist the cavity 802 of the female mold 80. Thus, the housing 100 defines an opening therein. The buffer cushion 40 is positioned around the opening.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a housing, comprising:
providing a buffer cushion;
fixing the buffer cushion in an injection mold; and
injecting molten material into the injection mold to form a housing, with the housing attached to the buffer cushion.

2. The method for manufacturing a housing as claimed in claim 1, wherein the buffer cushion is fabric, rubber, or other material.

3. The method for manufacturing a housing as claimed in claim 1, wherein the injection mold comprises a male mold and a female mold matching the male mold, and the male mold comprises a protruding portion disposed thereon, on which the buffer cushion is positioned.

4. The method for manufacturing a housing as claimed in claim 3, wherein the protruding portion comprises a positioning portion extending therefrom, around which the buffer cushion is positioned.

5. The method for manufacturing a housing as claimed in claim 4, wherein the height of the positioning portion equals the thickness of the buffer cushion.

6. The method for manufacturing a housing as claimed in claim 4, wherein height of the protruding portion exceeds the thickness of the buffer cushion.

7. The method for manufacturing a housing as claimed in claim 4, wherein the positioning portion comprises at least three positioning posts, by which the buffer cushion is positioned on the male mold.

8. The method for manufacturing a housing as claimed in claim 1, wherein the injection mold comprises a male mold and a female mold matching the male mold, the male mold defining a plurality of air suction holes, through which vacuum force is applied to draw the molds together.

9. The method for manufacturing a housing as claimed in claim 1, wherein the housing is polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof.

10. A housing comprising:
a main body; and
a buffer cushion positioned on the main body.

11. The housing as claimed in claim 10, wherein the buffer cushion is fabric, rubber, or other material.

12. The housing as claimed in claim 10, wherein the housing is polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof.
